(19) United States
(12) Patent Application Publication
(10) Pub. No.: US 2024/0076447 A1
(43) Pub. Date: Mar. 7, 2024

(54) IONIC LIQUID-IMMOBILIZED TITANIUM-SILICON MOLECULAR SIEVE CATALYST AND PREPARATION METHOD AND USE THEREOF, AND METHOD FOR PREPARING POLY (BUTYLENE SUCCINATE)

(71) Applicant: Beihang University, Beijing (CN)

(72) Inventors: Penggang Yin, Beijing (CN); Yukun Gao, Beijing (CN); Jihua Shi, Beijing (CN)

(21) Appl. No.: 18/203,419

(22) Filed: May 30, 2023

(30) Foreign Application Priority Data
Sep. 1, 2022 (CN) 202211061378.3

(51) Int. Cl. C08G 63/85; C08G 63/16

(52) U.S. Cl. CPC C08G 63/85; C08G 63/16

(57) ABSTRACT

The present disclosure includes an ionic liquid-immobilized titanium-silicon molecular sieve catalyst and a preparation method and use thereof, and a method for preparing poly(butylene succinate). The ionic liquid-immobilized titanium-silicon molecular sieve catalyst further includes a titanium-silicon molecular sieve along with an acidic ionic liquid bonded to the titanium-silicon molecular sieve.

### CROSS REFERENCE TO RELATED APPLICATION

This patent application claims the benefit and priority of Chinese Patent Application No. 202211061378.3 filed with the China National Intellectual Property Administration on Sep. 1, 2022, the disclosure of which is incorporated by reference herein in its entirety as part of the present application.

### TECHNICAL FIELD

The present disclosure relates to the technical field of catalysts, in particular to an ionic liquid-immobilized titanium-silicon molecular sieve catalyst and a preparation method and use thereof, and a method for preparing poly(butylene succinate) (PBS).

### BACKGROUND

Due to the non-degradability of traditional plastics, plastic products bring convenience and benefits to people's life and industrial production, but meanwhile lead to more and more serious environmental pollution problems. Degradable plastics are an important way to solve this problem. Poly(butylene succinate) (PBS) obtained by polymerization of petroleum raw materials succinic acid and butanediol is a typical biodegradable plastic, which can replace traditional plastics to be widely used in various fields of human life. Currently, the PBS is extensively developed.

High-molecular-weight PBS has a comprehensive performance equivalent to that of polypropylene. In order to prepare the high-molecular-weight PBS, domestic and foreign scholars have explored many methods. For example, DAE KYUNG SONG (DAE KYUNG SONG, YONGKIEL SUNG, Journal of Applied Polymer Science, 1995 Vol. 56, 1381-1395) has prepared PBS with a number-average molecular weight of 16,000 by solution polymerization for 20 h, but the product still has a lower molecular weight. As another example, CN1424339A has disclosed that succinic acid and butanediol are subjected to an esterification at 160° C. for 3 h to 4 h at ambient pressure, organic tin and cadmium acetate are added step by step as catalysts, and polycondensation is conducted under high temperature and high vacuum for 9 h to prepare PBS with a weight-average molecular weight of 137,000 and a molecular weight distribution of 1.9. Although the high-molecular-weight PBS is prepared, this method involves relatively complicated processes and requires the catalysts added in batches, and also needs long reaction time and high cost.

Another effective method to improve the molecular weight is chain extension. With regard to the preparation of high-molecular-weight PBS by chain extension, Showa Highpolymer Co., Ltd. (Japan) has achieved a relatively successful case. The company uses PBS with a number-average molecular weight of at least 10,000 as a prepolymer, and diisocyanate as a chain extender to prepare high-molecular-weight PBS by melt reaction. A specific preparation process (disclosed in U.S. Pat. Nos. 5,391,644, 5,348,700, and 5,525,409) includes the following steps: conducting an esterification reaction of 1,4-butanedioic acid and butanediol at 190° C. to 210° C. under ambient pressure for 3.5 h, conducting polycondensation at 190° C. to 210° C. for 3.5 h under a vacuum degree of 2 mmHg to 20 mmHg, adding a catalyst to a resulting reaction system, and then continuing the polycondensation at 215° C. to 220° C. for 5.5 h under a vacuum degree of 15 mmHg to 0.2 mmHg, to obtain a succinic acid-butylene glycol prepolymer with a number-average molecular weight of 16,800 and a weight-average molecular weight of 43,600; and conducting a reaction between the prepolymer and the diisocyanate for 1 h at a temperature of 180° C. to 200° C. to prepare a PBS product with a number-average molecular weight of 35,500 and a weight-average molecular weight of 170,000. However, due to a wide molecular weight distribution (4.8), the product has limited strength, long production cycle, and high preparation cost, which greatly limits its application range.

Most of the catalysts used in the PBS synthesis are heavy metal catalysts, such as stannous octoate, stannous chloride, dibutyltin oxide, and alkoxy antimony (CN103724599A and CN102019202A). Such metal catalysts have certain cytotoxicity, such that the degradation of materials may cause certain pollution to the environment. On the other hand, the PBS products synthesized by the direct method (using butanediol and succinic acid as raw materials) reported in the literature so far have a weight-average molecular weight (Mw) of not more than 1.4×10⁵. However, all the PBS products with the weight-average Mw of not less than 1.4×10⁵ are synthesized through chain extension of a medium-molecular-weight PBS, and the chain extenders (such as isocyanate) used have certain toxicity (Yanliang Wang et al., New Chemical Materials, 2011, 12, 43-45).

### SUMMARY

An object of the present disclosure is to provide an ionic liquid-immobilized titanium-silicon molecular sieve catalyst and a preparation method and use thereof, and a method for preparing PBS. In the present disclosure, the ionic liquid-immobilized titanium-silicon molecular sieve catalyst has no toxicity and a desirable catalytic effect. The catalyst can be used to prepare PBS with a weight-average Mw of not less than 1.4×10⁵.

To achieve the above object, the present disclosure provides the following technical solutions:

The present disclosure provides an ionic liquid-immobilized titanium-silicon molecular sieve catalyst, including a titanium-silicon molecular sieve and an acidic ionic liquid bonded to the titanium-silicon molecular sieve.

In some embodiments, the acidic ionic liquid is a sulfonic acid-type ionic liquid.

In some embodiments, the acidic ionic liquid is [HSO₃-pmim]H₂PO₄.

In some embodiments, the acidic ionic liquid accounts for 20% to 30% by mass of the ionic liquid-immobilized titanium-silicon molecular sieve catalyst.

The present disclosure further provides a method for preparing the ionic liquid-immobilized titanium-silicon molecular sieve catalyst, including the following steps:
mixing a titanium source, a silicon source, and a directing agent with water, to obtain a mixed solution;
dissolving the acidic ionic liquid in ethanol, to obtain an acidic ionic liquid solution; and
mixing the acidic ionic liquid solution, the mixed solution, cetyltrimethylammonium bromide (CTAB), and ammonia water with water to obtain a resulting mixture, and conducting an alkali treatment on the resulting mixture, to obtain the ionic liquid-immobilized titanium-silicon molecular sieve catalyst.

In some embodiments, an amount of the acidic ionic liquid is 10% to 15% of a total mass of the titanium source and the silicon source.

The present disclosure further provides use of the ionic liquid-immobilized titanium-silicon molecular sieve catalyst as described in the above technical solutions or the ionic liquid-immobilized titanium-silicon molecular sieve catalyst prepared by the method as described in the above technical solutions in the preparation of poly(butylene succinate) (PBS).

The present disclosure further provides a method for preparing PBS, including the following steps:
mixing succinic acid, succinic anhydride, and 1,4-butanediol, and conducting an esterification reaction on a resulting mixture under the action of a catalyst to obtain an oligomer, where the catalyst is the ionic liquid-immobilized titanium-silicon molecular sieve catalyst as described in the above technical solutions or the ionic liquid-immobilized titanium-silicon molecular sieve catalyst prepared by the method as described in the above technical solutions; and
under the action of the ionic liquid-immobilized titanium-silicon molecular sieve catalyst, heating the oligomer and conducting a polycondensation reaction on the oligomer, to obtain the PBS.

In some embodiments, an amount of the ionic liquid-immobilized titanium-silicon molecular sieve catalyst is 0.01% to 0.05% of a total mass of the succinic acid, the succinic anhydride, and the 1,4-butanediol.

In some embodiments, the polycondensation reaction is conducted at a temperature of 200° C. to 220° C. for 1 h to 3 h.

The present disclosure provides an ionic liquid-immobilized titanium-silicon molecular sieve catalyst, including a titanium-silicon molecular sieve and an acidic ionic liquid bonded to the titanium-silicon molecular sieve. In the present disclosure, an esterification stage of the PBS preparation involves protonation of the carboxylic acid, and thus the acidic ionic liquid has a good catalytic effect on the esterification and is environmentally-friendly. A synergistic effect of the titanium-silicon molecular sieve and the acidic ionic liquid is achieved on the polycondensation, thereby showing a good catalytic effect. The ionic liquid-immobilized titanium-silicon molecular sieve catalyst has dual catalytic effects, which not only shows a good catalytic activity at the esterification stage of the PBS preparation, and but also can shorten a polycondensation time and increase the molecular weight of the product at the polycondensation stage, thereby avoiding a low and non-concentrated molecular weight of the PBS in the prior art. Moreover, the ionic liquid-immobilized titanium-silicon molecular sieve catalyst is non-toxic and environmentally-friendly.

### DETAILED DESCRIPTION OF THE EMBODIMENTS

The present disclosure provides an ionic liquid-immobilized titanium-silicon molecular sieve catalyst, including a titanium-silicon molecular sieve and an acidic ionic liquid bonded to the titanium-silicon molecular sieve.

In the present disclosure, the ionic liquid-immobilized titanium-silicon molecular sieve catalyst includes a titanium-silicon molecular sieve. In some embodiments, the titanium-silicon molecular sieve has an average pore size of 0.55 nm. In some embodiments, the titanium-silicon molecular sieve has an average porosity of 64%. In some embodiments, the titanium-silicon molecular sieve comprises 5% of titanium and 95% of silicon.

In the present disclosure, the ionic liquid-immobilized titanium-silicon molecular sieve catalyst includes an acidic ionic liquid bonded to the titanium-silicon molecular sieve. In some embodiments, the acidic ionic liquid is a sulfonic acid-type ionic liquid, preferably [HSO₃-pmim]H₂PO₄.

In some embodiments of the present disclosure, the acidic ionic liquid accounts for 20% to 30% by mass, preferably 24% by mass of the ionic liquid-immobilized titanium-silicon molecular sieve catalyst.

The present disclosure further provides a method for preparing the ionic liquid-immobilized titanium-silicon molecular sieve catalyst, including the following steps:
mixing a titanium source, a silicon source, and a directing agent with water, to obtain a mixed solution;
dissolving the acidic ionic liquid in ethanol, to obtain an acidic ionic liquid solution; and
mixing the acidic ionic liquid solution, the mixed solution, cetyltrimethylammonium bromide (CTAB), and ammonia water with water to obtain a resulting mixture, and conducting an alkali treatment on the resulting mixture, to obtain the ionic liquid-immobilized titanium-silicon molecular sieve catalyst.

In the present disclosure, a titanium source, a silicon source, and a directing agent are mixed with water to obtain a mixed solution. In some embodiments, the titanium source is n-tetrabutyl titanate (Ti(OC₄H₉)₄). In some embodiments, the silicon source is tetraethyl orthosilicate (TEOS). In some embodiments, the directing agent is tetrapropylammonium hydroxide (TPAOH). In some embodiments, the water is deionized water. In some embodiments, a molar ratio of the titanium source, the silicon source, the directing agent, and water is in a range of 1:(15-30):8:500. In some embodiments, the mixing is conducted at 60° C.

In the present disclosure, the acidic ionic liquid is dissolved in ethanol to obtain an acidic ionic liquid solution. In some embodiments, the acidic ionic liquid solution has a concentration of 1 mol/L.

In the present disclosure, after obtaining the mixed solution and the acidic ionic liquid solution, the acidic ionic liquid solution, the mixed solution, CTAB, and ammonia water are mixed with water, obtaining a resulting mixture, and an alkali treatment is conducted on the resulting mixture, to obtain the ionic liquid-immobilized titanium-silicon molecular sieve catalyst. In some embodiments, the amount of the acidic ionic liquid is 10% to 15%, preferably 12% of the total mass of the titanium source and the silicon source. The CTAB can enhance an adsorption capacity to the acidic ionic liquid.

In some embodiments of the present disclosure, a step of mixing the acidic ionic liquid solution, the mixed solution, the CTAB, and the ammonia water with water includes: subjecting the acidic ionic liquid solution and the mixed solution to a first mixing, to obtain a clear solution of the directing agent; and subjecting the clear solution of the directing agent, the CTAB, the ammonia water, and water to a second mixing. In some embodiments, the first mixing is conducted at 60° C. In some embodiments, the first mixing is conducted for 2 h. In some embodiments, a ratio of the CTAB, the ammonia water, the water, and the clear solution of the directing agent is in a range of 1 g:(8-10) g:100 mL:(120-150) mL. In some embodiments, the ammonia water has a mass concentration of 25%.

In some embodiments of the present disclosure, the alkali treatment includes a sol reaction and an aging sequentially. In some embodiments, the sol reaction is conducted at a temperature of 35° C. to 45° C., preferably 40° C. In some embodiments, the sol reaction is conducted for 3 h to 8 h, preferably 5 h to 6 h. In some embodiments, the aging is conducted at 50° C. to 80° C., preferably 60° C. to 70° C. In some embodiments, the aging is conducted for 6 h to 18 h, preferably 12 h to 15 h. The sol reaction is conducted for purification, and the aging is conducted for crystallization.

In some embodiments of the present disclosure, after the alkali treatment, the obtained system is subjected to solid-liquid separation, and the obtained solid product is sequentially subjected to a washing, a drying at a room temperature, and a vacuum drying, to obtain the ionic liquid-immobilized titanium-silicon molecular sieve catalyst. In some embodiments, the vacuum drying is conducted at a temperature of 120° C. to 180° C., preferably 150° C. to 160° C. In some embodiments, the vacuum drying is conducted for 6 h to 8 h.

The present disclosure further provides use of the ionic liquid-immobilized titanium-silicon molecular sieve catalyst as described in the above technical solutions or the ionic liquid-immobilized titanium-silicon molecular sieve catalyst prepared by the method as described in the above technical solutions in the preparation of PBS. In the present disclosure, the ionic liquid-immobilized titanium-silicon molecular sieve catalyst has a good catalytic effect at not only the esterification stage but also the polycondensation stage of the PBS preparation; moreover, the catalyst can improve catalytic efficiency and catalytic selectivity, and suppress side reactions, which improves the stability of catalyst.

The present disclosure further provides a method for preparing PBS, including the following steps:
mixing succinic acid, succinic anhydride, and 1,4-butanediol, and conducting an esterification reaction on a resulting mixture under the action of a catalyst to obtain an oligomer, where the catalyst is the ionic liquid-immobilized titanium-silicon molecular sieve catalyst or the ionic liquid-immobilized titanium-silicon molecular sieve catalyst prepared by the method as described in the above technical solutions; and
under the action of the ionic liquid-immobilized titanium-silicon molecular sieve catalyst, heating the oligomer, and conducting a polycondensation reaction on the oligomer, to obtain the PBS.

In the present disclosure, succinic acid, succinic anhydride, and 1,4-butanediol are mixed, and the esterification reaction is conducted on a resulting mixture under the action of the ionic liquid-immobilized titanium-silicon molecular sieve catalyst to obtain an oligomer. In some embodiments, a molar ratio of the total of the succinic acid and the succinic anhydride to the 1,4-butanediol is in a range of 1:1 to 1:1.05, preferably 1:1.02 to 1:1.04. In some embodiments, a molar ratio of the succinic acid to the succinic anhydride is in a range of 1:0.5 to 1:1, and preferably 1:0.8 to 1:0.9.

In some embodiments of the present disclosure, the amount of the ionic liquid-immobilized titanium-silicon molecular sieve catalyst is 0.01% to 0.05%, preferably 0.03% to 0.04% the total mass of the succinic acid, the succinic anhydride, and the 1,4-butanediol.

In some embodiments of the present disclosure, the esterification reaction is conducted under ambient pressure. In some embodiments, the esterification reaction is conducted in a nitrogen atmosphere. In some embodiments, the esterification reaction is conducted at a temperature of 120° C. to 180° C., preferably 140° C. to 160° C. When an esterification rate reaches not less than 95% of a theoretically calculated value, the esterification reaction ends.

In the present disclosure, a polycondensation reaction is conducted on the oligomer by heating the oligomer under the action of the ionic liquid-immobilized titanium-silicon molecular sieve catalyst to obtain the PBS. The ionic liquid-immobilized titanium-silicon molecular sieve catalyst is the aforementioned ionic liquid-immobilized titanium-silicon molecular sieve catalyst used in the esterification reaction.

In some embodiments of the present disclosure, the polycondensation reaction is conducted at a temperature of 200° C. to 220° C., and preferably 210° C. to 220° C. In some embodiments, the polycondensation is conducted for 1 h to 3 h, preferably 1.5 h to 2 h. In some embodiments, the temperature is raised from the esterification temperature to the polycondensation temperature at a rate of 3° C./min to 25° C./min. In some embodiments, the polycondensation reaction is conducted under vacuum conditions, preferably at a vacuum degree of 50 Pa to 100 Pa, and more preferably 60 Pa to 80 Pa.

In some embodiments of the present disclosure, after the polycondensation, an obtained product is extruded and granulated to obtain the PBS.

In some embodiments of the present disclosure, the PBS has a weight-average molecular weight of (1.29-1.59)×10⁵, and a molecular weight distribution of 1.31 to 1.46. The film prepared from the PBS has a tensile strength of 46.84 MPa to 56.2 MPa, and an elongation at break of 356% to 413%.

In the present disclosure, the PBS synthesized by using the ionic liquid-immobilized titanium-silicon molecular sieve catalyst not only has a high molecular weight, but also has relatively high mechanical properties, which has improved application value.

The technical solutions of the present disclosure will be clearly and completely described below in conjunction with the examples of the present disclosure. Apparently, the described examples are only a part of, not all of the examples of the present disclosure. All other examples obtained by a person of ordinary skill in the art based on the examples of the present disclosure without creative labor shall fall within the scope of the present disclosure.

In the following use examples, the molecular weight of the product is determined by gel chromatography detection, a solvent for the gel chromatography detection is chloroform, a chromatograph is at 40° C., and a flow rate during measurement is in a range of 0.2 mL/min to 1 mL/min. A molecular weight calculation method includes: calculating Mi according to the equation: log Mi=0.3321×i+7.9553 (where i is a retention time, and Mi is the molecular weight of a polymer corresponding to the retention time i); and based on the Mi, calculating a weight-average molecular weight and a number-average molecular weight of the polymer. The calculation is according to the equation: Mw=ΣRIiMi/ΣRIi, Mn=ΣRIi/Σ(RIi/Mi); where Mw is the weight-average molecular weight, Mn is the number-average molecular weight, and RIi is a peak height at the retention time i.

The tensile strength and the elongation at break of the product are determined according to the national standard GB/T13022-1991.

### Example 1

Preparation of an ionic liquid-immobilized titanium-silicon molecular sieve catalyst:

(1) 1 mol of n-tetrabutyl titanate, 25 mol of tetraethyl orthosilicate, 8 mol of tetrapropylammonium hydroxide, and 500 mol of deionized water were mixed to be uniform, and heated to 60° C., obtaining a mixed solution.

Sulfonic acid ionic liquid [HSO₃-pmim]H₂PO₄ (in an amount of 12% of the total mass of the n-tetrabutyl titanate and the tetraethyl orthosilicate) was dissolved in absolute ethanol, obtaining an acidic ionic liquid solution with a concentration of 1 mol/L.

The acidic ionic liquid solution was added to the mixed solution which has been heated to 60° C. already, and stirred to be uniform. The resulting mixture was reacted for 2 h to obtain a clear solution of a directing agent.

(2) 10 g of CTAB, 90 g of 25 wt % ammonia water, 1000 mL of deionized water, and 1400 mL of the clear solution of the directing agent were mixed to be uniform, and reacted at 40° C. for 5 h. The resulting reaction solution was added into a polytetrafluoroethylene-lined reaction kettle and aged at 60° C. for 12 h, obtaining a product. The obtained product was successively subjected to suction filtration, washing, drying at a room temperature, and vacuum drying at 150° C. for 8 h, obtaining the ionic liquid-immobilized titanium-silicon molecular sieve catalyst.

### Use Example 1

(1) Esterification: succinic acid, succinic anhydride, and 1,4-butanediol were added to a reaction kettle (the molar ratio of the total of the succinic acid and the succinic anhydride to the 1,4-butanediol being 1:1, and the molar ratio of the succinic acid to the succinic anhydride being 1:1), and the ionic liquid-immobilized titanium-silicon molecular sieve catalyst prepared in Example 1 was added thereto, wherein the amount of the ionic liquid-immobilized titanium-silicon molecular sieve catalyst was 0.01% of the total mass of the succinic acid, the succinic anhydride, and the 1,4-butanediol. The esterification reaction was conducted under ambient pressure at 120° C. When an esterification rate reached not less than 95% of a theoretically calculated value, it was confirmed that the esterification reaction was complete, obtaining an oligomer.

(2) Polycondensation: under the action of the ionic liquid-immobilized titanium-silicon molecular sieve catalyst, the oligomer was heated to 200° C., stirred, and vacuumed to a vacuum degree of 100 Pa, and subjected to a polycondensation reaction for 1 h, obtaining a reaction product. The reaction product was extruded and granulated, obtaining PBS.

In this use example, the PBS has a weight-average molecular weight of 1.29×10⁵ and a molecular weight distribution of 1.46.

According to GB1040, a film prepared from the PBS has a tensile strength of 46.84 MPa and an elongation at break of 356%.

### Use Example 2

(1) Esterification: succinic acid, succinic anhydride, and 1,4-butanediol were added to a reaction kettle (the molar ratio of the total of the succinic acid and the succinic anhydride to the 1,4-butanediol being 1:1.05, and the molar ratio of the succinic acid to the succinic anhydride being 1:0.5), and the ionic liquid-immobilized titanium-silicon molecular sieve catalyst prepared in Example 1 was added thereto, wherein the amount of the ionic liquid-immobilized titanium-silicon molecular sieve catalyst was 0.05% of the total mass of the succinic acid, the succinic anhydride, and the 1,4-butanediol. The esterification reaction was conducted under ambient pressure at 180° C. When an esterification rate reached not less than 95% of a theoretically calculated value, it was confirmed that the esterification reaction was complete, obtaining an oligomer.

(2) Polycondensation: under the action of the ionic liquid-immobilized titanium-silicon molecular sieve catalyst, the oligomer was heated to 220° C., stirred and vacuumed to a vacuum degree of 50 Pa, and subjected to a polycondensation reaction for 3 h, obtaining a reaction product. The reaction product was extruded and granulated, obtaining PBS.

In this use example, the PBS has a weight-average molecular weight of 1.35×10⁵ and a molecular weight distribution of 1.41.

According to GB1040, a film prepared from the PBS has a tensile strength of 49.71 MPa and an elongation at break of 381%.

### Use Example 3

(1) Esterification: succinic acid, succinic anhydride, and 1,4-butanediol were added to a reaction kettle (the molar ratio of the total of succinic acid and succinic anhydride to the 1,4-butanediol being 1:1.02, and the molar ratio of succinic acid to succinic anhydride being 1:0.8), and the ionic liquid-immobilized titanium-silicon molecular sieve catalyst prepared in Example 1 was added thereto, wherein the amount of the ionic liquid-immobilized titanium-silicon molecular sieve catalyst was 0.03% of the total mass of the succinic acid, the succinic anhydride, and the 1,4-butanediol. The esterification reaction was conducted under ambient pressure at 160° C. When an esterification rate reached not less than 95% of a theoretically calculated value, it was confirmed that the esterification reaction was complete, obtaining an oligomer.

(2) Polycondensation: under the action of the ionic liquid-immobilized titanium-silicon molecular sieve catalyst, the oligomer was heated to 210° C., stirred and vacuumed to a vacuum degree of 80 Pa, and subjected to a polycondensation reaction for 2 h, obtaining a reaction product. The reaction product was extruded and granulated, obtaining PBS.

In this use example, the PBS has a weight-average molecular weight of 1.52×10⁵ and a molecular weight distribution of 1.33.

According to GB1040, a film prepared from the PBS has a tensile strength of 55.3 MPa and an elongation at break of 407%.

### Use Example 4

(1) Esterification: succinic acid, succinic anhydride, and 1,4-butanediol were added to a reaction kettle (the molar ratio of the total of the succinic acid and the succinic anhydride to the 1,4-butanediol being 1:1.02, and the molar ratio of the succinic acid to the succinic anhydride being 1:0.9), and the ionic liquid-immobilized titanium-silicon molecular sieve catalyst prepared in Example 1 was added thereto, wherein the amount of the ionic liquid-immobilized titanium-silicon molecular sieve catalyst was 0.03% of the total mass of the succinic acid, the succinic anhydride, and the 1,4-butanediol. The esterification reaction was conducted under ambient pressure at 160° C. When an esterification rate reached not less than 95% of a theoretically calculated value, it was confirmed that the esterification reaction was complete, obtaining an oligomer.

(2) Polycondensation: under the action of the ionic liquid-immobilized titanium-silicon molecular sieve catalyst, the oligomer was heated to 220° C., stirred and vacuumed to a vacuum degree of 50 Pa, and subjected to a polycondensation reaction for 1.5 h, obtaining a reaction product. The reaction product was extruded and granulated, obtaining PBS.

In this use example, the PBS has a weight-average molecular weight of 1.59×10⁵ and a molecular weight distribution of 1.31.

According to GB1040, a film prepared from the PBS has a tensile strength of 56.2 MPa and an elongation at break of 413%.

### Comparative Example 1

(1) Esterification: succinic acid, succinic anhydride, and 1,4-butanediol were added to a reaction kettle (the molar ratio of the total of the succinic acid and the succinic anhydride to the 1,4-butanediol being 1:1.02, and the molar ratio of the succinic acid to the succinic anhydride being 1:0.9), and a [HSO₃-pmim]H₂PO₄ catalyst was added thereto, wherein the amount of the catalyst was 0.03% of the total mass of the succinic acid, the succinic anhydride, and the 1,4-butanediol. The esterification reaction was conducted under ambient pressure at 160° C. When an esterification rate reached not less than 95% of a theoretically calculated value, it was confirmed that the esterification reaction was complete, obtaining an oligomer.

(2) Polycondensation: under the action of the [HSO₃-pmim]H₂PO₄ catalyst, the oligomer was heated to 220° C., stirred and vacuumed to a vacuum degree of 50 Pa, and subjected to a polycondensation reaction for 1.5 h, obtaining a reaction product. The reaction product was extruded and granulated, obtaining PBS.

In this comparative example, the PBS has a weight-average molecular weight of 0.8×10⁵ and a molecular weight distribution of 1.51. According to GB1040, a film prepared from the PBS has a tensile strength of 35.8 MPa and an elongation at break of 210%.

### Comparative Example 2

(1) Esterification: succinic acid, succinic anhydride, and 1,4-butanediol were added to a reaction kettle (the molar ratio of the total of the succinic acid and the succinic anhydride to the 1,4-butanediol being 1:1.02, and the molar ratio of the succinic acid to the succinic anhydride being 1:0.9), and a titanium-silicon molecular sieve catalyst was added thereto, wherein the amount of the catalyst was 0.03% of the total mass of the succinic acid, the succinic anhydride, and the 1,4-butanediol. The resulting mixture was subjected to an esterification reaction under ambient pressure at 160° C. When an esterification rate reached not less than 95% of a theoretically calculated value, it was confirmed that the esterification reaction was complete, obtaining an oligomer.

(2) Polycondensation: under the action of the titanium-silicon molecular sieve catalyst, the oligomer was heated to 220° C., stirred and vacuumed to a vacuum degree of 50 Pa, and subjected to a polycondensation reaction for 1.5 h, obtaining a reaction product. The reaction product was extruded and granulated, obtaining PBS.

In this comparative example, the PBS has a weight-average molecular weight of 1.01×10⁵ and a molecular weight distribution of 1.59. According to GB1040, a film prepared from the PBS has a tensile strength of 36.3 MPa and an elongation at break of 224%.

The results of the above use examples and comparative examples show that the ionic liquid-immobilized titanium-silicon molecular sieve catalyst according to the present disclosure has a good catalytic effect, not only at the esterification stage but also at the polycondensation stage. The esterification involves the protonation of carboxylic acid, and the acidic ionic liquid has a good catalytic effect on the esterification and is environmentally-friendly. A synergistic effect of the titanium-silicon molecular sieve and the acidic ionic liquid is achieved on the polycondensation, showing a good catalytic effect. The catalyst according to the present disclosure has a function of double catalysis, which shortens the polycondensation time, and still results in an excellent product quality. In the present disclosure, the PBS synthesized by using the ionic liquid-immobilized titanium-silicon molecular sieve catalyst not only has a high molecular weight, but also has better mechanical properties, which has improved use value.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. An ionic liquid-immobilized titanium-silicon molecular sieve catalyst, comprising a titanium-silicon molecular sieve and an acidic ionic liquid bonded to the titanium-silicon molecular sieve.

2. The ionic liquid-immobilized titanium-silicon molecular sieve catalyst as claimed in claim 1, wherein the acidic ionic liquid is a sulfonic acid-type ionic liquid.

3. The ionic liquid-immobilized titanium-silicon molecular sieve catalyst as claimed in claim 1, wherein the acidic ionic liquid is [HSO₃-pmim]H₂PO₄.

4. The ionic liquid-immobilized titanium-silicon molecular sieve catalyst as claimed in claim 1, wherein the acidic ionic liquid accounts for 20% to 30% by mass of the ionic liquid-immobilized titanium-silicon molecular sieve catalyst.

5. A method for preparing an ionic liquid-immobilized titanium-silicon molecular sieve catalyst,
the ionic liquid-immobilized titanium-silicon molecular sieve catalyst comprising a titanium-silicon molecular sieve and an acidic ionic liquid bonded to the titanium-silicon molecular sieve;
the method comprising the steps of
mixing a titanium source, a silicon source, and a directing agent with water, to obtain a mixed solution;
dissolving the acidic ionic liquid in ethanol, to obtain an acidic ionic liquid solution; and
mixing the acidic ionic liquid solution, the mixed solution, cetyltrimethylammonium bromide, and ammonia water with water, to obtain a resulting mixture, and conducting an alkali treatment on the resulting mixture, to obtain the ionic liquid-immobilized titanium-silicon molecular sieve catalyst.

6. The method as claimed in claim 5, wherein the acidic ionic liquid is in an amount of 10% to 15% of a total mass of the titanium source and the silicon source.

7. A method for preparing poly(butylene succinate) by using the ionic liquid-immobilized titanium-silicon molecular sieve catalyst of claim 1, comprising the steps of
mixing succinic acid, succinic anhydride, and 1,4-butanediol, and conducting an esterification reaction on a resulting mixture under the action of the ionic liquid-immobilized titanium-silicon molecular sieve catalyst of claim 1, to obtain an oligomer; and
under the action of the ionic liquid-immobilized titanium-silicon molecular sieve catalyst of claim 1, heating the oligomer and conducting a polycondensation reaction on the oligomer, to obtain the poly(butylene succinate).

8. The method as claimed in claim 7, wherein the ionic liquid-immobilized titanium-silicon molecular sieve catalyst is in an amount of 0.01% to 0.05% of a total mass of the succinic acid, the succinic anhydride, and the 1,4-butanediol.

9. The method as claimed in claim 7, wherein the polycondensation reaction is conducted at a temperature of 200° C. to 220° C. for 1 h to 3 h.

10. The method as claimed in claim 8, wherein the polycondensation reaction is conducted at a temperature of 200° C. to 220° C. for 1 h to 3 h.

11. The ionic liquid-immobilized titanium-silicon molecular sieve catalyst as claimed in claim 2, wherein the acidic ionic liquid is [HSO₃-pmim]H₂PO₄.

12. The method as claimed in claim 5, wherein the acidic ionic liquid is a sulfonic acid-type ionic liquid.

13. The method as claimed in claim 5, wherein the acidic ionic liquid is [HSO₃-pmim]H₂PO₄.

14. The method as claimed in claim 5, wherein the acidic ionic liquid accounts for 20% to 30% by mass of the ionic liquid-immobilized titanium-silicon molecular sieve catalyst.
